(19) United States
(12) Patent Application Publication
(10) Pub. No.: US 2026/0050359 A1
(43) Pub. Date: Feb. 19, 2026

(54) HANDHELD ELECTRONIC APPARATUS AND METHOD FOR OPENING OPERATION INTERFACE OF APPLICATION PROGRAM

(71) Applicant: ASUSTeK COMPUTER INC., Taipei City (TW)

(72) Inventors: Chia-In Liao, Taipei City (TW); Li-Te Yang, Taipei City (TW); Yung-Hsuan Kao, Taipei City (TW); Shun-Wen Huang, Taipei City (TW)

(73) Assignee: ASUSTeK COMPUTER INC., Taipei City (TW)

(21) Appl. No.: 19/211,267

(22) Filed: May 18, 2025

(30) Foreign Application Priority Data
Aug. 13, 2024 (TW) 113130278

(51) Int. Cl. G06F 3/0482; G06F 3/0484; G06F 3/0488

(52) U.S. Cl. CPC G06F 3/0482; G06F 3/0484; G06F 3/0488

(57) ABSTRACT

A handheld electronic apparatus and a method for opening an operation interface of an application program are provided. The method for opening the operation interface of the application program is suitable for a handheld electronic apparatus including a touch screen. The method includes the following steps. An icon of an application program is displayed on a function menu through the touch screen. A triggering gesture applied to the icon is received through the touch screen. It is determined whether a current operation state of the handheld electronic apparatus matches a historical opening scene of the application program. When the current operation state of the handheld electronic apparatus matches the historical opening scene of the application program, a first interface display state corresponding to the historical opening scene is obtained, and the operation interface of the application program is displayed according to the first interface display state through the touch screen.

### CROSS-REFERENCE TO RELATED APPLICATION

This application claims the priority benefit of Taiwan application serial no. 113130278, filed on Aug. 13, 2024. The entirety of the above-mentioned patent application is hereby incorporated by reference herein and made a part of this specification.

### BACKGROUND

### Technical Field

The disclosure relates to a handheld electronic apparatus and a method for opening an operation interface of an application program.

### Description of Related Art

Touch screens have become a common feature of handheld electronic apparatuses, and touch screens allow users to view display images and intuitively perform touch operations. A user can open an application program by touching the icon of the application program. However, as the functions of handheld electronic apparatuses become increasingly rich, users often need to perform cumbersome touch operations to open or close application programs. Moreover, after opening an application program each time, a user often needs to adjust the operation interface of the application program to a display state that suits his/her personal operating habits, such as adjusting the display position or display size, etc. Such repetitive and cumbersome operation steps are not only time-consuming, but also bring an unfavorable user experience to users.

### SUMMARY

The disclosure provides a method for opening an operation interface of an application program suitable for a handheld electronic apparatus including a touch screen, and the method includes the following steps. An icon of an application program is displayed on a function menu through the touch screen. A triggering gesture applied to the icon is received through the touch screen. It is determined whether a current operation state of the handheld electronic apparatus matches a historical opening scene of the application program. When the current operation state of the handheld electronic apparatus matches the historical opening scene of the application program, a first interface display state corresponding to the historical opening scene is obtained, and the operation interface of the application program is displayed according to the first interface display state through the touch screen.

The disclosure further provides a handheld electronic apparatus including a touch screen, a storage device, and a processor. The storage device records a plurality of commands. The processor is coupled to the touch screen and the storage device and executes the command to execute the following steps. An icon of an application program is displayed on a function menu through the touch screen. A triggering gesture applied to the icon is received through the touch screen. It is determined whether a current operation state of the handheld electronic apparatus matches a historical opening scene of the application program. When the current operation state of the handheld electronic apparatus matches the historical opening scene of the application program, a first interface display state corresponding to the historical opening scene is obtained, and the operation interface of the application program is displayed according to the first interface display state through the touch screen.

Based on the above, in the disclosure, when the user issues a triggering gesture to the icon of the application program displayed on the touch screen, it can be determined whether the current operation state of the handheld electronic apparatus matches the historical opening scene of the application program. When the current operation state of the handheld electronic apparatus matches the historical opening scene of the application program, the operation interface of the application program may be displayed according to the first interface display state corresponding to the historical opening scene. In this way, the user does not need to manually adjust the interface position and size of the operation interface of the application program, and the operation interface of the application program is automatically displayed on the touch screen in a state that matches the user's habits. The convenience of operating the application program is thus improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a handheld electronic apparatus according to an embodiment of the disclosure.

FIG. 2 is a flow chart of a method for opening an operation interface of an application program according to an embodiment of the disclosure.

FIG. 3A is a schematic view of opening a function menu according to an embodiment of the disclosure.

FIG. 3B is a schematic view of receiving a triggering gesture applied to an icon according to an embodiment of the disclosure.

FIG. 4A is a schematic view of a small-window mode according to an embodiment of the disclosure.

FIG. 4B is a schematic view of a split-screen mode according to an embodiment of the disclosure.

FIG. 4C is a schematic view of a one-handed operation mode according to an embodiment of the disclosure.

FIG. 4D is a schematic view of a full-screen mode according to an embodiment of the disclosure.

FIG. 5 is a schematic view of a handheld electronic apparatus according to an embodiment of the disclosure.

FIG. 6 is a flow chart of a method for opening an operation interface of an application program according to an embodiment of the disclosure.

FIG. 7A to FIG. 7C are schematic views of displaying an operation interface of an application program according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts. The embodiments are only a portion of the disclosure, which do not present all embodiments of the disclosure. More specifically, the embodiments serve as examples of the apparatus and method fall within the scope of the claims of the disclosure.

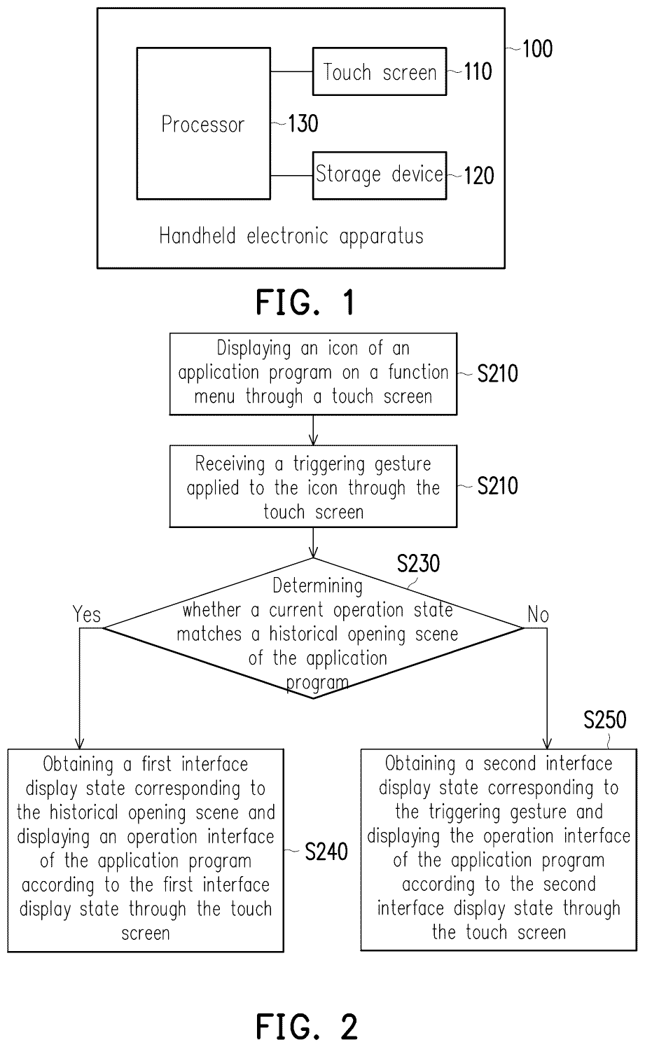

With reference to FIG. 1, a handheld electronic apparatus 100 is, for example, a smart phone, a tablet computer, a game console, a smart wearable apparatus, or other electronic apparatuses having a touch screen and installed with an application program, but the disclosure is not limited thereto. The handheld electronic apparatus 100 includes a touch screen 110, a storage device 120, and a processor 130. The processor 130 is coupled to the touch screen 110 and the storage device 120, and the functions are described as follows.

The touch screen 110 is a display device integrated with touch detection elements and can provide both display and input functions. This display device is, for example, a liquid crystal display (LCD), a light-emitting diode (LED) display, a field emission display (FED), an organic light-emitting diode (OLED) display, or other types of display devices, but the disclosure is not limited thereto. The touch detection elements are disposed on the display device, and these sensing elements are configured to receive touch operations. The touch detection elements may be, for example, capacitive touch detection elements, surface acoustic wave touch detection elements, electromagnetic touch detection elements, near field imaging touch detection elements, and the like.

The storage device 120 is used to store data such as a file, an image, a command, a program code, a software module, etc., and may be, for example, a fixed or movable random access memory (RAM) in any form, a read-only memory (ROM), a flash memory, a hard disc or other similar devices, an integrated circuit, and a combination thereof.

The processor 130 is, for example, a central processing unit (CPU), an application processor (AP), a programmable microprocessor for general or special use, a digital signal processor (DSP), a programmable controller, an application specific integrated circuit (ASIC), a programmable logic device (PLD), a graphics processing unit (GPU) or other similar devices, or a combination of the foregoing devices.

The processor 130 may execute the program codes, software modules, commands, etc. recorded in the storage device 120 to implement a method for opening an operation interface of an application program provided by the embodiments of the disclosure. The software module may be broadly construed to mean a command, a command set, a code, a program code, a program, an application, a software package, a thread, a procedure, a function, etc. The following is an example to illustrate the detailed steps of the method for opening the operation interface of the application program performed by the handheld electronic apparatus 100.

FIG. 2 is a flow chart of a method for opening an operation interface of an application program according to an embodiment of the disclosure. With reference to FIG. 1 and FIG. 2, the method provided by this embodiment is applicable to the handheld electronic apparatus 100 provided by the foregoing embodiments, and the steps of the method for opening the operation interface of the application program provided by this embodiment are described in detail as follows together with the various elements in the handheld electronic apparatus 100.

In step S210, the processor 130 displays an icon of an application program on a function menu through the touch screen 110. In some embodiments, the application program may be, for example, an email application program, a multimedia application program, a camera application program, a browser application program, a social application program, a game application program, a widget application program, or other types of application programs. The disclosure is not limited thereto.

In some embodiments, when a specific gesture is received through the touch screen 110, the processor 130 may control the touch screen 110 to display the function menu. That is, a user may open the function menu through a specific gesture, and this function menu includes one or a plurality of application program icons. The application programs in the function menu may be selected by the user or selected based on the frequency of use of the application programs. The function menu may be a drop-down menu or a side function menu. The disclosure is not limited thereto. The function menu includes icon(s) of one or a plurality of application programs.

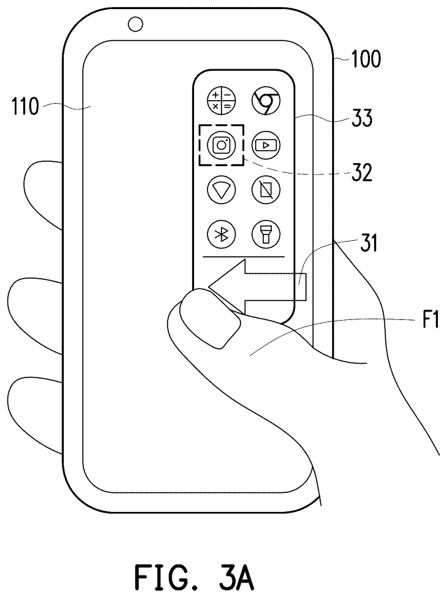

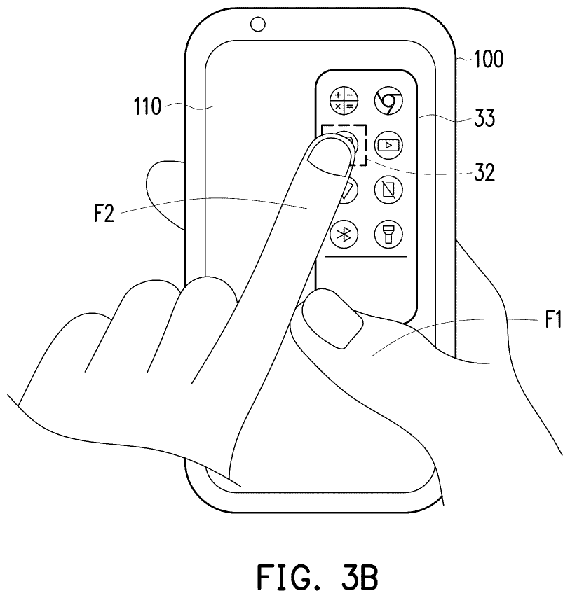

For instance, with reference to FIG. 3A, which is a schematic view of opening the function menu according to an embodiment of the disclosure. In some embodiments, the specific gesture used to open the function menu may be a sliding gesture starting from an edge of the screen. When the processor 130 determines that the touch origin of the sliding gesture received by the touch screen 110 is located at a screen edge 31 of the touch screen 110, the processor 130 may control the touch screen 110 to display a function menu 33. The function menu 33 may include icon(s) (e.g., an icon 32) of one or more application programs. Alternatively, in other embodiments, the specific gesture used to open the function menu may be a double tap gesture located at the edge of the screen.

In step S220, the processor 130 receives a triggering gesture applied to the icon through the touch screen 110. When the user issues the triggering gesture to the icon in the function menu displayed on the touch screen 110, the processor may receive the triggering gesture applied to the icon through the touch screen 110. That is, the triggering gesture is a touch gesture applied to the touch screen 110.

For instance, with reference to FIG. 3B, which is a schematic view of receiving a triggering gesture applied to the icon according to an embodiment of the disclosure. After the touch screen 110 displays the function menu 33, the processor 130 may detect a triggering gesture applied to the icon 32 in the function menu 33. To be specific, when the user wants to open the operation interface of a specific application program, the user may give a triggering gesture to the icon of the application program after the function menu 33 is displayed. The triggering gesture may be a single tap gesture, a double tap gesture, a long press gesture, a drag gesture, or other touch gestures. That is, when the processor 130 receives a triggering gesture applied to the icon, the processor 130 may determine to open the operating interface of the application program. In this disclosure, opening the operation interface of an application program means displaying the operation interface of the application program on the touch screen 110.

In step S230, the processor 130 determines whether a current operation state matches a historical opening scene of the application program. In some embodiments, the current operation state includes a running foreground application program, a current display state of the handheld electronic apparatus 100, or an application program list including a plurality of running application programs. The current display state of the handheld electronic apparatus 100 may be a vertical screen operation state or a horizontal screen operation state. In some embodiments, the current operation state may also include sensing data of a sensor of the handheld electronic apparatus 100, such as current ambient brightness, a motion state, etc. of the handheld electronic apparatus 100.

To be specific, the processor 130 determines whether the current operation state of opening a specific application program is consistent with the historical opening scene of opening the same application program in the past. Correspondingly, in some embodiments, scene information of the historical opening scene may include a historical foreground application program, a historical display state, or a historical application program list. A historical display state of the handheld electronic apparatus 100 may be the vertical screen operation state or the horizontal screen operation state. In some embodiments, the scene information of the historical opening scene may also include historical sensing data, such as historical ambient brightness, a historical motion state, etc. of the handheld electronic apparatus 100. The scene information of the historical opening scene may be recorded in the storage device 120.

In some embodiments, the processor 130 may determine whether the foreground application program in the current operation state matches the historical foreground application program in the historical opening scene. In some embodiments, the processor 130 may determine whether the current display state of the handheld electronic apparatus 100 in the current operation state matches the historical display state of the historical opening scene. In some embodiments, the processor 130 may determine whether the application program list of the current operation state matches the historical application program list of the historical opening scene. In some embodiments, the processor 130 may determine whether the current ambient brightness matches the historical ambient brightness. In some embodiments, the processor 130 may determine whether the current motion state matches the historical motion state.

In step S240, when the current operation state of the handheld electronic apparatus 100 matches the historical opening scene of the application program, the processor 130 obtains a first interface display state corresponding to the historical opening scene and displays the operation interface of the application program according to the first interface display state through the touch screen 110. That is, when the user opens the application program again in the same operation scene, the processor 130 may control the touch screen 110 to display the operation interface of the application program according to the previously recorded first interface display state.

In some embodiments, the first interface display state may be one of a plurality of interface display modes. The plurality of interface display modes include a small-window mode, a split-screen mode, a one-handed operation mode, and a full-screen mode. The first interface display state may further include an interface display parameter of one of the plurality of interface display modes. The interface display parameter includes an interface size and an interface position.

In step S250, when the current operation state of the handheld electronic apparatus 100 does not match the historical opening scene of the application program, the processor 130 may obtain a second interface display state corresponding to the triggering gesture and displays the operation interface of the application program according to the second interface display state through the touch screen 110. That is, when the user opens an application program in an unrecorded new operation scene, the processor 130 may control the touch screen 110 to display the operation interface of the application program according to the second interface display state corresponding to the triggering gesture.

In some embodiments, the second interface display state corresponding to the triggering gesture may be one of the plurality of interface display modes. The plurality of interface display modes include the small-window mode, the split-screen mode, the one-handed operation mode, and the full-screen mode. The second interface display state corresponding to the triggering gesture may also include the interface display parameter of one of the plurality of interface display modes. The interface display parameter includes the interface size and the interface position.

In some embodiments, when the triggering gesture matches a first predetermined gesture, the processor 130 may determine the second interface display state to be a first interface display mode among the plurality of interface display modes. When the triggering gesture matches a second predetermined gesture, the processor 130 may determine the second interface display state to be a second interface display mode among the plurality of interface display modes. The first interface display mode is different from the second interface display mode.

For instance, when the triggering gesture matches the double tap gesture, the processor 130 may determine that the second interface display state is the small-window mode. When the triggering gesture matches the long press gesture, the processor 130 may determine that the second interface display state is the split-screen mode.

It can be seen that the operation interface of the application program may be presented on the touch screen 110 according to the interface display state corresponding to the touch gesture or the interface display state corresponding to the historical opening scene. Therefore, the user does not need to manually adjust the operation interface of the application program repeatedly. In this way, operational efficiency and convenience may be improved.

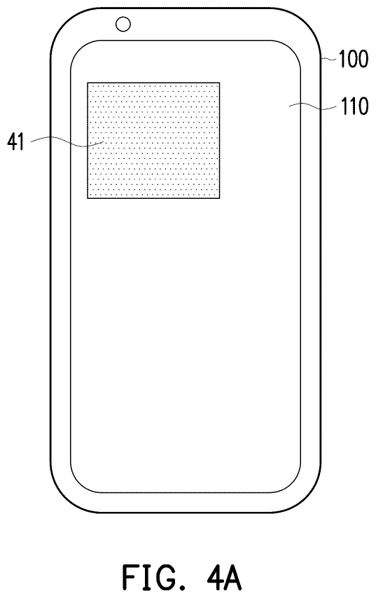

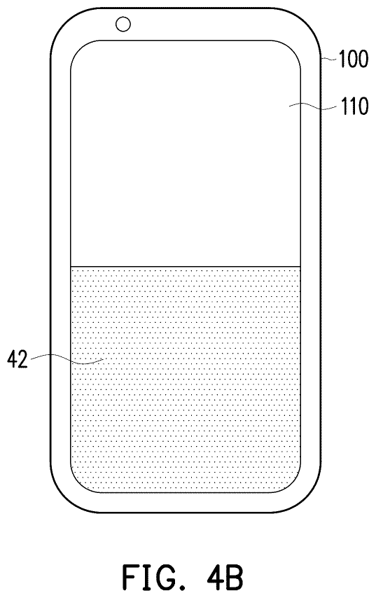

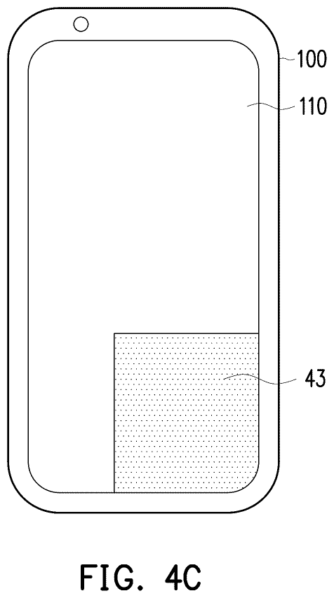

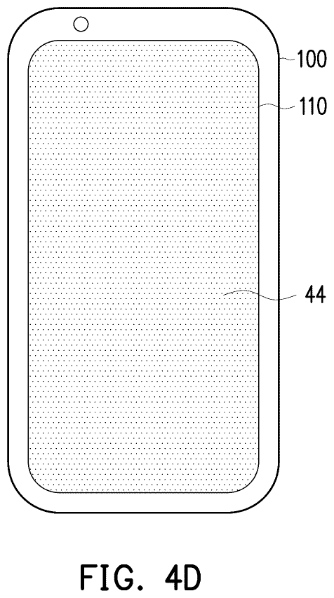

With reference to FIG. 4A, which is a schematic view of the small-window mode according to an embodiment of the disclosure. When the operation interface of the application program is displayed in the small-window mode, the processor 130 may display the operation interface of the application program in a small window 41. This small window may be overlaid on the desktop or on the operation interface of other application programs.

With reference to FIG. 4B, which is a schematic view of the split-screen mode according to an embodiment of the disclosure. When the operation interface of the application program is displayed in the split-screen mode, the processor 130 may divide a display range of the touch screen 110 into an upper display range and a lower display range and displays the operation interface of the application program in a lower display range 42 of the touch screen 110. However, in other embodiments, the processor 130 may display the operation interface of the application program in the upper display range of the touch screen 110.

With reference to FIG. 4C, which is a schematic view of the one-handed operation mode according to an embodiment of the disclosure. When the operation interface of the application program is displayed in the one-handed mode, the processor 130 may display the operation interface of the application program in a one-handed operation range 43. The one-handed operation range 43 is the reachable range of the thumb when holding the handheld electronic apparatus 100 with one hand. The one-handed operation range 43 may be attached to the edge of the screen of the touch screen 110.

With reference to FIG. 4D, which is a schematic view of the full-screen mode according to an embodiment of the disclosure. When the operation interface of the application program is displayed in the full-screen mode, the processor 130 may display the operation interface of the application program in an entire display range 44 of the touch screen 110.

It should be noted that after opening the operation interface of the application program, the user may adjust the interface display parameter, such as the interface size and the interface position. The processor 130 may record the interface display parameter adjusted by the user and use the adjusted interface display parameter when the application program is opened in the same operation scene next time. The following examples are given to illustrate clearly.

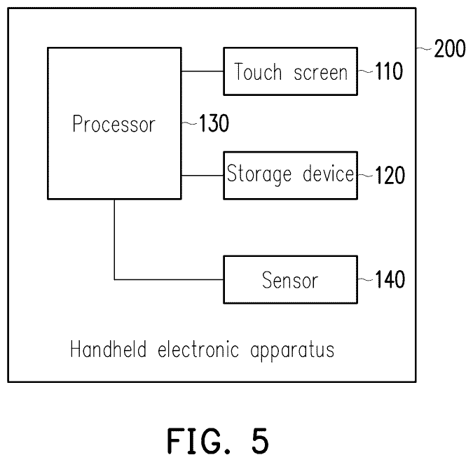

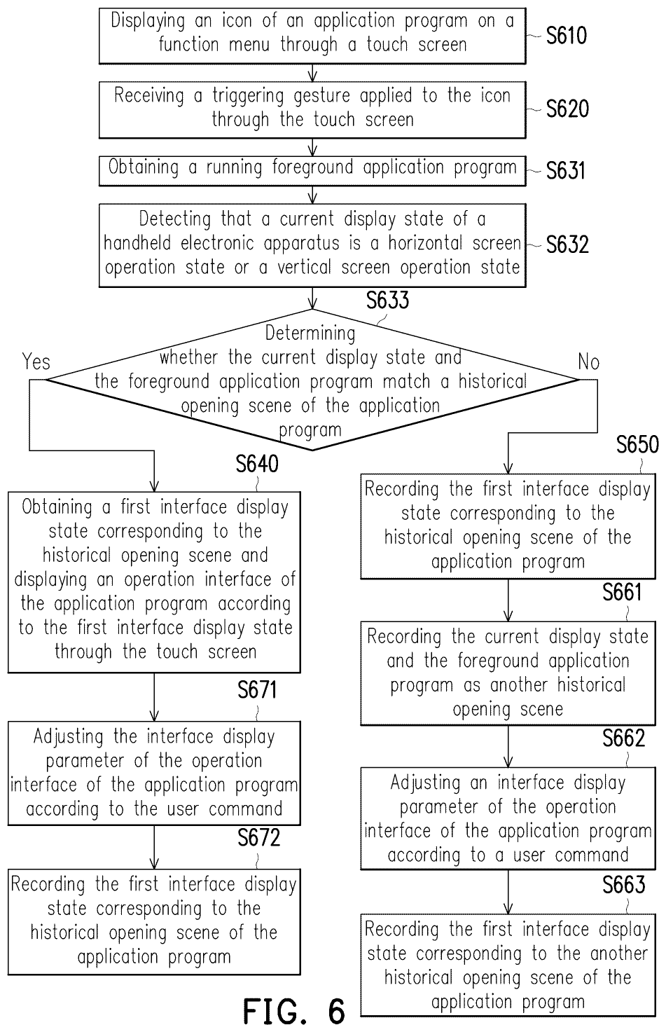

With reference to FIG. 5, a handheld electronic apparatus 200 may include the touch screen 110, the storage device 120, the processor 130, and a sensor 140. The processor 130 may be coupled to the touch screen 110, the storage device 120, and the sensor 140. The touch screen 110, the storage device 120, and the processor 130 are described in the aforementioned embodiments and are not to be elaborated herein.

In some embodiments, the sensor 140 may be a gravity sensor, and the processor 130 may detect whether a current display state of the handheld electronic apparatus 200 is a horizontal screen operation state or a vertical screen operation state according to gravity sensing data of the sensor 140.

In other embodiments, the sensor 140 may be a sensing element, such as a brightness sensor, an inertia sensor, a motion sensor, or an image sensor, etc., capable of sensing environmental information or an apparatus state of the handheld electronic apparatus 200. The current operation state of the handheld electronic apparatus 200 may include sensing data of the sensor 140.

FIG. 6 is a flow chart of a method for opening an operation interface of an application program according to an embodiment of the disclosure. With reference to FIG. 5 and FIG. 6, the method provided by this embodiment is applicable to the handheld electronic apparatus 200 provided by the foregoing embodiments, and the steps of the method for opening the operation interface of the application program provided by this embodiment are described in detail as follows together with the various elements in the handheld electronic apparatus 200.

In step S610, the processor 130 displays an icon of an application program on a function menu through the touch screen 110. In step S620, the processor 130 receives a triggering gesture applied to the icon through the touch screen 110. In step S630, the processor 130 determines whether a current operation state matches a historical opening scene of the application program.

In the embodiment shown in FIG. 6, step S630 may be implemented as step S631 to step S633. In step S631, the processor 130 may obtain a running foreground application program. In step S632, the processor 130 may detect that a current display state of the handheld electronic apparatus 200 is a horizontal screen operation state or a vertical screen operation state through the sensor 140. In step S633, the processor 130 may determine whether the current display state and the foreground application program of the handheld electronic apparatus 200 match the historical opening scene of the application program.

In step S640, when the current display state and the foreground application program of the handheld electronic apparatus 200 match the historical opening scene of the application program, the processor 130 obtains a first interface display state corresponding to the historical opening scene and displays the operation interface of the application program according to the first interface display state through the touch screen 110.

For instance, the historical opening scene of the application program and the corresponding first interface display state may be shown in Table 1 below.

TABLE 1

| | Historical opening scene | | Interface display state | |
|---|---|---|---|---|
| Application | Historical foreground | Historical | Interface display | Interface display |
| program | application program | display state | mode | parameter |
| Computer | browser | vertical screen | small-window | A window position, |
| | | operation state | mode | A window size |
| | Email | vertical screen | small-window | B window position, |
| | | operation state | mode | B window size |
| | Notepad | vertical screen | split-screen | display height |
| | | operation state | mode | |
| Browser | game | horizontal | small-window | C window position, |
| | | screen | mode | C window size |
| | | operation state | | |
| | social media | vertical screen | full-screen mode | |
| | | operation state | | |

In the example of Table 1, when the user opens the computer when the current display state of the handheld electronic apparatus 200 is “vertical screen operation state” and the foreground application program is “browser”, the processor 130 determines that the current display state and the foreground application program of the handheld electronic apparatus 200 match the historical opening scene. Therefore, the processor 130 determines that the operation interface of the computer is displayed in the small-window mode. However, Table 1 is merely an exemplary description and is not intended to limit the disclosure.

Next, in step S671, the processor 130 may adjust an interface display parameter of the operation interface of the application program according to a user command. Further, the processor 130 may receive a user command applied to the operation interface of the application program, such as a dragging gesture for adjusting the size and position of a window. Next, the processor 130 responds to the user command and adjusts the interface display parameter of the operation interface of the application program, such as the interface position or the interface size.

In step S672, the processor 130 may record the first interface display state corresponding to the historical opening scene of the application program according to an adjustment result of the operation interface of the application program. Further, the processor 130 may update the first interface display state corresponding to the historical opening scene. Taking Table 1 as an example, after the processor 130 displays the operation interface of the computer according to the “A window position” and the “A window size”, the operation interface of the computer may move from the “A window position” to the “D window position” in response to the user's command. Therefore, the processor 130 updates the interface position in the first interface display state corresponding to the historical opening scene, that is, updates the “A window position” to the “D window position”.

On the other hand, in step S650, when the current display state and the foreground application program of the handheld electronic apparatus 200 do not match the historical opening scene of the application program, the processor 130 obtains a second interface display state corresponding to the triggering gesture and displays the operation interface of the application program according to the second interface display state through the touch screen 110.

In step S661, the processor 130 may record another historical opening scene of the application program according to the current operation state of the handheld electronic apparatus 200. That is, when the current display state and the foreground application program of the handheld electronic apparatus 200 do not match the historical opening scene of the application program, the processor 130 may record the current display state and the foreground application program as another historical opening scene. In step S662, the processor 130 may adjust the interface display parameter of the operation interface of the application program according to the user command. In step S663, the processor 130 may record the first interface display state corresponding to the another historical opening scene of the application program. That is, after the new another historical opening scene is generated, the processor 130 may record the first interface display state corresponding to the another historical opening scene of the application program according to the adjustment result of the operation interface of the application program.

In some embodiments, when the running foreground application program matches a first historical foreground application program in the historical opening scene, the first interface display state corresponding to the historical opening scene is a first interface display mode among a plurality of interface display modes. When the running foreground application program matches a second historical foreground application program in the historical opening scene, the first interface display state corresponding to the historical opening scene is a second interface display mode among the plurality of interface display modes. The first interface display mode is different from the second interface display mode. That is, when the same application program is opened while different foreground applications are running, the application program may be displayed in different interface display modes.

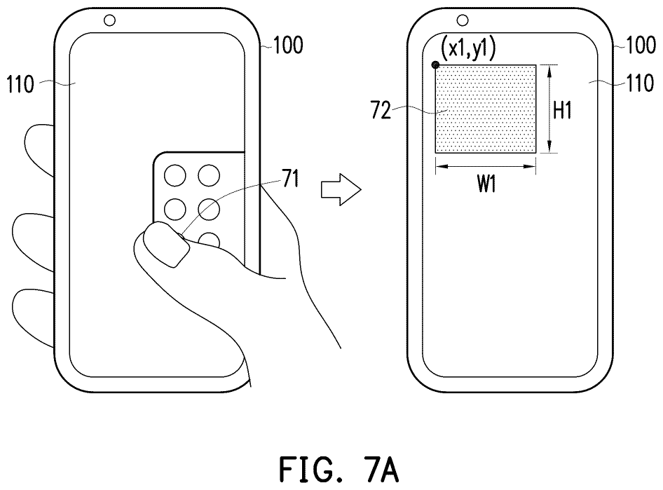

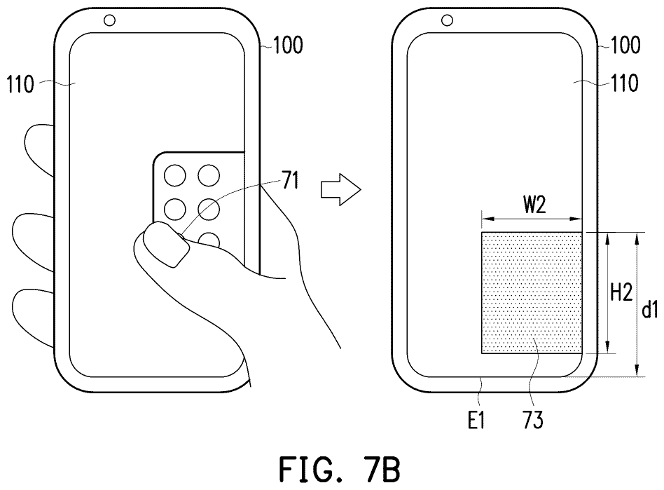

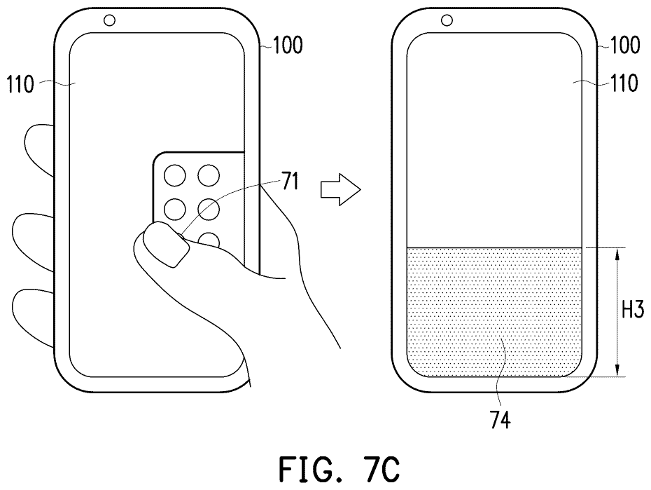

With reference to FIG. 7A, the processor 130 may detect a triggering gesture applied to an icon 71 of the application program “Application A”. When the running foreground application program “Application B” does not match the historical opening scene, the processor 130 may display the operation interface of “Application A” in a small window 72 according to the small-window mode and the interface display parameter corresponding to the triggering gesture. The processor 130 may display the small window 72 according to the interface position and the interface size in the interface display parameter. In this example, the interface position may be a window vertex position (x1, y1), and the interface size may be a window width W1 and a window height H1.

With reference to FIG. 7B, the processor 130 may detect a triggering gesture applied to the icon 71 of the application program “Application A”. When the running foreground application program “Application C” matches the historical foreground application program of the historical opening scene, the processor 130 may display the operation interface of “Application A” in a one-handed operation range 73 according to the one-handed operation mode and the interface display parameter corresponding to the historical opening scene. The processor 130 may display the one-handed operation range 73 according to the interface position and the interface size in the interface display parameter. In this example, the interface position may be a distance d1 between an upper boundary of the one-handed operation range 73 and a bottom edge E1 of the screen. The interface size may be a width W2 of the one-handed operation range 73 and a height H2 of the one-handed operation range 73.

With reference to FIG. 7C, the processor 130 may detect a triggering gesture applied to the icon 71 of the application program “Application A”. When the running foreground application program “Application C” matches the historical foreground application program of the historical opening scene, the processor 130 may display the operation interface of “Application A” in a lower display range 74 of the touch screen 110 according to the split-screen mode and the interface display parameter corresponding to the historical opening scene. The processor 130 may display the lower display range 74 according to the interface size in the interface display parameter. In this example, the interface size may be a height H3 of the lower display range 74.

In view of the foregoing, in the embodiments of the disclosure, when the user issues a triggering gesture to the icon of the application program displayed on the touch screen, it can be determined whether the current operation state of the handheld electronic apparatus matches the historical opening scene of the application program. When the current operation state of the handheld electronic apparatus matches the historical opening scene of the application program, the operation interface of the application program may be displayed according to the first interface display state corresponding to the historical opening scene. In this way, the user does not need to manually adjust the interface position and size of the operation interface of the application program, and the operation interface of the application program is automatically displayed on the touch screen in a state that matches the user's habits. The convenience of operating the application program is thus improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for opening an operation interface of an application program, suitable for a handheld electronic apparatus comprising a touch screen, the method comprising:
displaying an icon of an application program on a function menu through the touch screen;
receiving a triggering gesture applied to the icon through the touch screen;
determining whether a current operation state of the handheld electronic apparatus matches a historical opening scene of the application program; and
obtaining a first interface display state corresponding to the historical opening scene when the current operation state of the handheld electronic apparatus matches the historical opening scene of the application program and displaying the operation interface of the application program according to the first interface display state through the touch screen.

2. The method for opening the operation interface of the application program according to claim 1, further comprising:
controlling the touch screen to display the function menu when a specific gesture is received through the touch screen,
wherein the function menu comprises the icon of the application program.

3. The method for opening the operation interface of the application program according to claim 1, further comprising:
obtaining a second interface display state corresponding to the triggering gesture when the current operation state of the handheld electronic apparatus does not match the historical opening scene of the application program and displaying the operation interface of the application program according to the second interface display state through the touch screen.

4. The method for opening the operation interface of the application program according to claim 3, further comprising:
recording another historical opening scene of the application program according to the current operation state of the handheld electronic apparatus; and
recording the first interface display state corresponding to the another historical opening scene of the application program.

5. The method for opening the operation interface of the application program according to claim 3, wherein the step of obtaining the second interface display state corresponding to the triggering gesture comprises:
determining the second interface display state to be a first interface display mode among a plurality of interface display modes when the triggering gesture matches a first predetermined gesture; and
determining the second interface display state to be a second interface display mode among the plurality of interface display modes when the triggering gesture matches a second predetermined gesture, wherein the first interface display mode is different from the second interface display mode.

6. The method for opening the operation interface of the application program according to claim 1, wherein the step of determining whether the current operation state of the handheld electronic apparatus matches the historical opening scene of the application program comprises:
obtaining a running foreground application program;
detecting that a current display state of the handheld electronic apparatus is a horizontal screen operation state or a vertical screen operation state; and
determining whether the current display state and the foreground application program of the handheld electronic apparatus match the historical opening scene of the application program.

7. The method for opening the operation interface of the application program according to claim 1, further comprising:
receiving a user command applied to the operation interface of the application program;
adjusting an interface display parameter of the operation interface of the application program according to the user command; and
recording the first interface display state corresponding to the historical opening scene of the application program according to an adjustment result of the operation interface of the application program.

8. The method for opening the operation interface of the application program according to claim 7, wherein the interface display parameter comprises an interface size and an interface position.

9. The method for opening the operation interface of the application program according to claim 1, wherein when the running foreground application program matches a first historical foreground application program in the historical opening scene, the first interface display state corresponding to the historical opening scene is a first interface display mode among a plurality of interface display modes, when the running foreground application program matches a second historical foreground application program in the historical opening scene, the first interface display state corresponding to the historical opening scene is a second interface display mode among the plurality of interface display modes, and the first interface display mode is different from the second interface display mode.

10. The method for opening the operation interface of the application program according to claim 9, wherein the plurality of interface display modes comprise a small-window mode, a split-screen mode, a one-handed operation mode, and a full-screen mode.

11. A handheld electronic apparatus, comprising:
a touch screen;
a storage device recording a plurality of commands; and
a processor coupled to the touch screen and the storage device, executing the plurality of command, and configured to:
display an icon of an application program on a function menu through the touch screen,
receive a triggering gesture applied to the icon through the touch screen,
determine whether a current operation state of the handheld electronic apparatus matches a historical opening scene of the application program, and
obtain a first interface display state corresponding to the historical opening scene when the current operation state of the handheld electronic apparatus matches the historical opening scene of the application program and display the operation interface of the application program according to the first interface display state through the touch screen.
